(19) United States
(12) Patent Application Publication
(10) Pub. No.: US 2007/0070856 A1
(43) Pub. Date: Mar. 29, 2007

(54) MP3 accessory for music transfer from a CD

(76) Inventor: Murray Tebele, Deal, NJ (US)

Correspondence Address: EZRA SUTTON P.A., Plaza 9 Building, 900 Route 9 North, Woodbridge, NJ, 07095, US

(21) Appl. No.: 11/234,964

(22) Filed: Sep. 26, 2005

(51) Int. Cl. G11B 3/64

(52) U.S. Cl. 369/85

(57) ABSTRACT

An MP3 transfer accessory for transferring music from a CD to an MP3 player: The MP3 transfer accessory includes a portable housing having a CD receiving station for receiving therein a CD to be uploaded to an MP3 player. The CD receiving station includes a CD reader for reading the music tracks on the CD placed in the CD receiving station. The transfer accessory further includes means for reading the data in the CD reader and for converting the CD format to MP3 readable format; such reading means include music transfer software and hardware. The housing further includes an integral MP3 docking station for receiving an MP3 player therein for receiving music from the CD placed in the CD receiving station. The MP3 docking station includes a docking connector for electrically connecting the MP3 player to the transfer accessory. The housing further includes an LCD screen for displaying data as to the CD music track being copied and as to the CD music tracks to be copied. The MP3 transfer accessory includes a power supply for providing power to the transfer accessory, and also includes a battery charger device, a battery pack or an electrical 110V plug for connecting to an electrical 110V outlet. Also provided is a power button for activating and deactivating the power supply.

### FIELD OF THE INVENTION

The present invention relates to a portable MP3 transfer accessory that transfers music from a CD (compact disc) directly to an MP3 player, or transfers video and audio from a DVD to an MP3 player. More particularly, this MP3 transfer accessory includes an MP3 docking station that electronically connects the transfer accessory to the MP3 player and also includes a CD receiving station for receiving therein a music CD. Additionally, an LCD screen permits the user to select the desired tracks of music to be copied from the CD and to upload the selected music tracks to the MP3 player in MP3-readable format.

### BACKGROUND OF THE INVENTION

Music CD's have replaced audio/music cassette tapes, such that most music “aficionados” own dozens of music CD's that they have collected over a long period of time. Most music CD users take a large number of CD's from their CD collection for transport and use them in their vehicles, camping, vacations, and the like, for playing on a CD player. This transport of CD's becomes a physical problem when transporting multiple CD's to the various locations desired where the user may want to listen to the music. Some users solve the problem of physically carrying around their CD's by using a computer to convert one or more CD's in their collection into a format that they can play on a portable MP3 player or other music player, such as the APPLE iPod® device. This conversion process works by loading the music CD into a computer C drive, using ripping software to copy the music to the computer's hard drive, and then using the same or separate software to encode the music into a format such as MP3 or WAV that can be loaded onto a portable MP3 player. After loading a portable music player's memory with a compressed version of music from the original CD's, there is no need to carry around the original CD's. This manual process works fine as long as the number of CD's that need conversion is very small. If a user has dozens of CD's that they would like to load onto a portable music player or other device, they have to manually load and repeat this process for each CD one by one. This process can require many hours of attention by the user to keep loading and attending to the CD's being converted.

Some people use an audio CD changer, such as the SONY Mega 300 CD Changer, to store and manage playback of their CD's through a home sound system. Many digital jukebox devices, such as the ESCIENT Fireball product, can control such audio CD changers and some can even copy one or more CD's in the CD changer to the jukebox hard drive or onto a CD-R/RW in an encoded format such as MP3. Once the music on the CD's have been encoded, they can be used for playback on the jukebox device itself or from any CD playback device that supports the encoded format. For example, some digital jukebox devices have a port allowing for direct transfer of compressed CD's onto a portable music device. The problem with the audio CD changer conversion approach is that in order for the CD music to be copied, they must actually be played through the audio port at regular speed (1×). By requiring playback through the audio port for the data to be accessible for copying means, it could take dozens or hundreds of hours for a large CD collection to be converted to a compressed format. This is not practical in such situations.

Therefore, there remains a need for an MP3 transfer accessory for directly transferring music tracks from a music CD to an MP3 player without the use of complex computer hardware and software. Additionally, there is a need for a transfer accessory that is faster and has an easier system and method for transferring the music tracks of multiple music CD's to an MP3 player.

### DESCRIPTION OF THE PRIOR ART

CD recorders having various accessories, designs, configurations and materials of construction have been disclosed in the prior art. For example, U.S. Patent Publication No. 2005/0117464 to AKITA discloses the use of a computer that is normally functional for converting one or more CD's in their collection into a format which can be played on a portable MP3 player or other music player, such as the APPLE iPod device. The conversion process works by loading the music CD into a computer CD drive, using ripping software to copy the music to the computer's hard drive, and then using the same or separate software to encode the music into a format such as MP3 or WAV that can be loaded onto a portable player. After loading a portable music player's memory with a compressed version of music from the original CD's, there is no need to carry around the original CD's. This prior art publication does not disclose or teach the concept and structure of a portable MP3 transfer accessory for transferring music tracks from a CD of the present invention.

U.S. Pat. No. 6,587,404 to KELLER discloses a compact disc recording device that includes a housing, sound receiving means for receiving audio signals, a compact disc recorder for recording onto a compact disc, and data storage structure in the housing for scoring audio signals. The compact disc recording device is configured such that a music library of sound tracks is storable in the data storage structure, and the compact disc recording device includes means for selecting a set of sound tracks from the music library to be recorded onto a compact disc by the compact disc recorder. The housing includes a display which identifies at least one sound track of the music library. This prior art patent does not disclose or teach the concept and structure of a portable MP3 transfer accessory for transferring music tracks from a CD of the present invention.

None of the aforementioned prior art references disclose or teach the structure, design and configuration for an MP3 transfer accessory for directly transferring music tracks from a music CD directly to an iPod® or MP3 player device, as claimed in the present invention.

Accordingly, it is an object of the present invention to provide an MP3 transfer accessory for directly transferring music tracks from a music CD to an MP3 player without the use of a computer.

Another object of the present invention is to provide an MP3 transfer accessory that increases the speed and efficiency of transferring music tracks on CD's to the MP3 player since the user does not have to link the MP3 player to a computer.

Another object of the present invention is to provide an MP3 transfer accessory that has a CD cartridge being integrally connected to the MP3 transfer accessory for receiving multiple music CD's therein.

Another object of the present invention is to provide an MP3 transfer accessory that includes an LCD screen for displaying the progress of transferring the music tracks from the CD, as well as to allow the user to specify which music tracks to copy.

Another object of the present invention is to provide an MP3 transfer accessory that reads the music CD, rips the music tracks and compresses the music tracks into a user-defined bitrate of an MPEG3 format.

Another object of the present invention is to provide an MP3 transfer accessory that is easy to use with minimal operational push-button functions on the transfer accessory.

A further object of the present invention is to provide an MP3 transfer accessory that can be mass-produced in an automated and economical manner and is readily affordable by the consumer.

### SUMMARY OF THE INVENTION

In accordance with the present invention, there is provided an MP3 transfer accessory for transferring music from a CD to an MP3 player: The MP3 transfer accessory includes a portable housing having a CD receiving station for receiving therein a CD to be uploaded to an MP3 player. The CD receiving station includes a CD reader for reading the music tracks on the CD placed in the CD receiving station. The transfer accessory further includes means for reading the data in the CD reader and for converting the CD format to MP3 readable format; such reading means include music transfer software and hardware. The housing further includes an integral MP3 docking station for receiving an MP3 player therein for receiving music from the CD placed in the CD receiving station. The MP3 docking station includes a docking connector for electrically connecting the MP3 player to the transfer accessory. The housing further includes an LCD screen for displaying data as to the CD music track being copied and as to the CD music tracks to be copied. The MP3 transfer accessory includes a power supply for providing power to the transfer accessory, and also includes a battery charger device, a battery pack or an electrical 110V plug for connecting to an electrical 110V outlet. Also provided is a power button for activating and deactivating the power supply.

### BRIEF DESCRIPTION OF THE DRAWINGS

Further objects, features, and advantages of the present invention will become apparent upon the consideration of the following detailed description of the presently-preferred embodiment when taken in conjunction with the accompanying drawings, wherein:

FIG. 1 is a top perspective view of the MP3 transfer accessory of the preferred embodiment of the present invention showing an MP3 or an iPod® device within an MP3 docking station of the MP3 transfer accessory and a CD being partially received within an insertion slot or CD receiving station on a side wall of the MP3 transfer accessory;

FIG. 2 is an exploded perspective view of the MP3 transfer accessory of the preferred embodiment of the present invention showing the MP3 or iPod® device being received within the MP3 docking station of the MP3 transfer accessory and the CD being inserted within the insertion slot of the MP3 transfer accessory;

FIG. 3 is a bottom perspective view of the MP3 transfer accessory of the present invention showing a bottom wall having a battery compartment cover thereon and a front wall having a CD receiving station slot therein;

FIG. 4 is an exploded bottom perspective view of the MP3 transfer accessory of the present invention showing a battery compartment, a battery pack, a 9V battery, a plurality of AA batteries, a battery charger and the CD receiving station slot;

FIG. 5 is an exploded perspective view of the MP3 transfer accessory of the alternate embodiment of the present invention showing the MP3 transfer accessory having a detachably connected CD cartridge for receiving multiple music CD's therein and an MP3 player being received within the MP3 docking station of the MP3 transfer accessory;

FIG. 6 is a schematic representation of the MP3 transfer accessory of the present invention showing the transfer accessory and a detachable CD cartridge being electrically connected to an LCD screen and the LCD screen electrically connected to the MP3 player; and

FIG. 7 is an electrical schematic diagram of the MP3 transfer accessory of the present invention showing the electrical connections for a power source, a power ON-OFF button, a software chip, a CD reader, a CD docking station having a docking connector and an MP3 docking charger, an LCD screen and an iPod® player.

### DETAILED DESCRIPTION OF THE PREFERRED EMBODIMENT 10

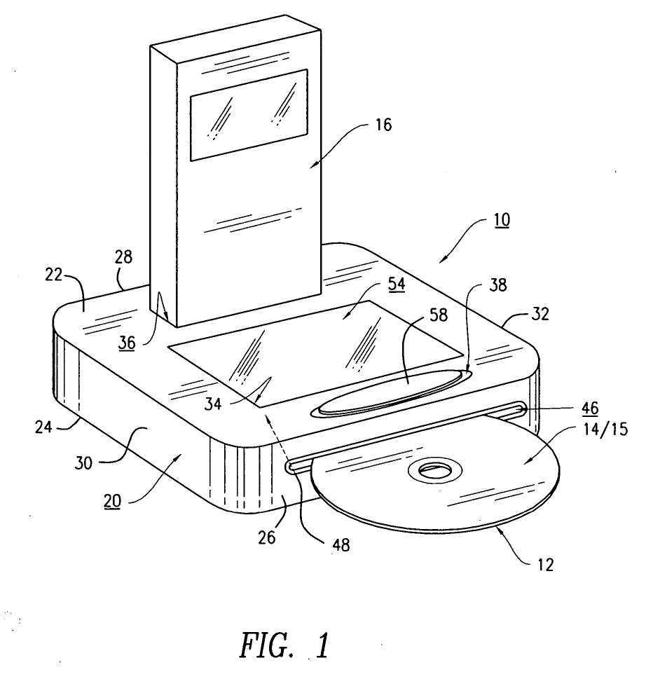

The MP3 transfer accessory device 10 and its component parts of the preferred embodiment of the present invention are represented in detail by FIGS. 1 to 7 of the patent drawings. The MP3 transfer accessory device 10 is used for the transferring of multiple music tracks 14 from a CD (compact disc) 12 to an MP3 player 16 or an iPod® 16p. It is understood that the track titles and album titles on the music CD's 12 are recognized by using an updatable, music recognition database, such as GRACE NOTE™, or any other similar database. Further, when the present invention refers to an MP3 player 16, it should be understood to include any portable multimedia player, such as an iPod® 16p.

As shown in FIGS. 1 through 4, the MP3 transfer accessory device 10 includes a portable accessory housing 20 having a top wall 22, a bottom wall 24, a front wall 26, a rear wall 28, a left side wall 30 and a right side wall 32. The top wall 22 of accessory housing 20 includes a screen opening 34, a docking station compartment 36 and a button or switch opening 38. The bottom wall 24 of accessory housing 20 includes a battery compartment cover 40 and an interior space 42 for receiving a battery compartment 44 therein.

The front wall 26 of accessory housing 20 includes a CD receiving station slot 46 for receiving therein the music CD 12 to be uploaded to the MP3 player 16. The CD receiving station slot 46 includes a CD reader 48 for reading the music tracks 14 on the CD 12 placed within the CD receiving station slot 46.

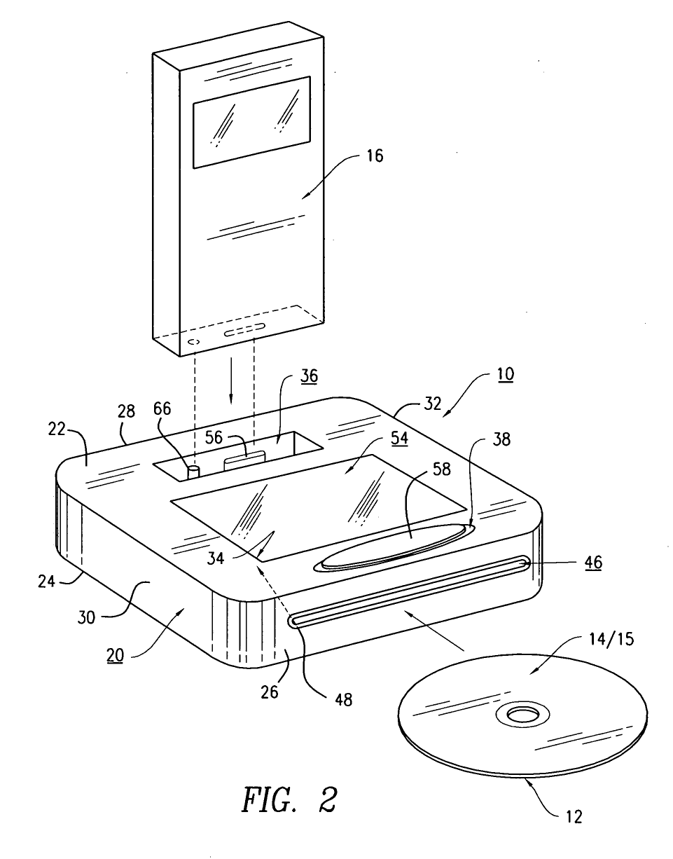

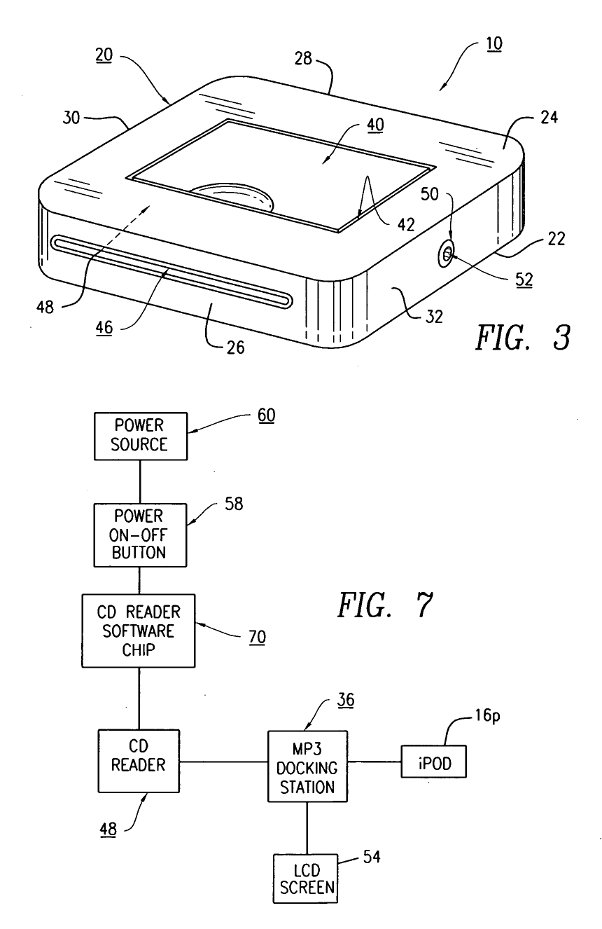

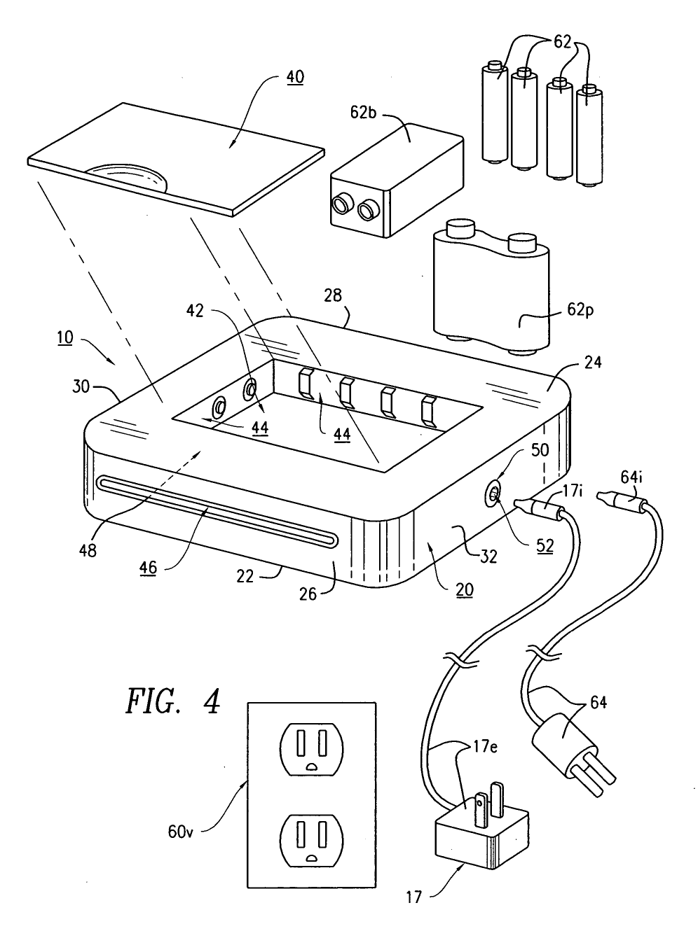

The first (right side) sidewall 30 includes an opening 50 for receiving a plug inlet connector member 52. As shown in FIGS. 3 and 4, the plug inlet connector member 52 receives a standard battery charger 17 with cord and plug 17p. The screen opening 34 on top wall 22 is for receiving an LCD screen 54 therein. The LCD screen 54 allows user input and status output in order for the user to display music transfer progress, as well as to allow the user to specify which music tracks 14 of the music CD 12 to copy. The integral MP3 docking station compartment 36 on top wall 22 is used for receiving the MP3 player 16 therein for receiving music 15 from the CD 12 placed in the CD receiving station slot 46, as depicted in FIG. 2. The integral MP3 docking station compartment 36 on top wall 22 includes a docking connector 56 for electrically connecting the MP3 player 16 to the MP3 transfer accessory device 10, as shown in FIGS. 1 and 2 of the patent drawings. The button/switch opening 38 on top wall 22 includes a power button/switch 58 for activating and deactivating the power supply 60, such as a standard 110V outlet 60 v.

The battery compartment 44 within bottom wall 24 is used for receiving one or more standard batteries 62 or a 9V battery 62b, as shown in FIG. 4 of the drawings. Alternatively, the battery compartment 44 can receive a battery pack 62p therein. Alternatively, the plug inlet connector member 52 can receive a standard electrical cord and plug 64 having an inlet plug 64i. Cord and plug 64 is received within a standard 110V outlet 60 v as shown in FIG. 4 of the drawings. Additionally, the MP3 docking station compartment 36 further includes a charger receptacle 66 for charging the MP3 player when docked in the MP3 docking station compartment 36.

As shown in FIG. 7, the electrical schematic diagram fo rthe MP3 transfer accessory device 10 includes a power source 60, a software chip 70 for providing the means of converting (uploading from a CD 12 and downloading to an iPod® 16p) the music track 14 information from the CD reader 48 to the LCD screen 54 and to the docking connector 56 and MP3 docking charger of the MP3 docking station 36 and electrically connecting to the MP3 player 16.

It should be understood that the use herein of MP3 is intended to include any compressed audio format, including, but not limited to, MP4, WMA, and AAC. Also, the use herein of CD is intended to include DVD, and the transfer of video and audio from the DVD to the player unit 10.

### First Alternate Embodiment 100

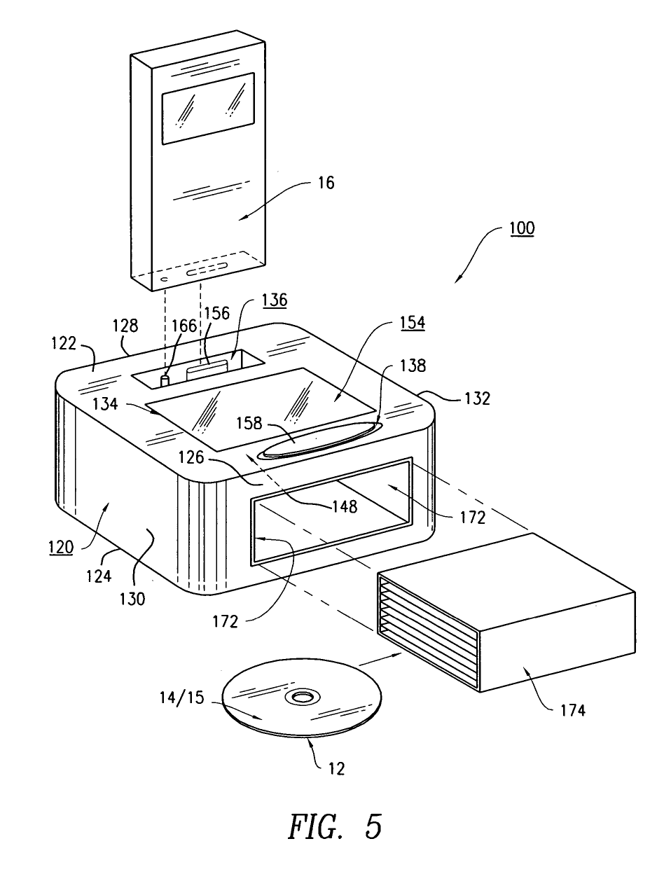

The MP3 transfer accessory device 100 and its component parts of the first alternate embodiment of the present invention are represented in detail by FIG. 5 of the patent drawings. Elements illustrated in FIG. 5 which correspond to the elements described above with reference to FIGS. 1 through 4 have been designated by corresponding reference numbers increased by one hundred. The first alternate embodiment 100 is similarly constructed and operates in the same manner as the preferred embodiment 10, unless it is otherwise stated. All aspects of the first alternate embodiment of the MP3 transfer accessory device 100 are the same as the preferred embodiment of the MP3 transfer accessory device 10 except for the design and configuration of the front wall 126 of accessory housing 120 having a CD cartridge receiving station opening 172 for receiving a CD cartridge member 174 therein, as depicted in FIG. 5, for holding and dispensing multiple CD's 12 to the CD reader 148 within the CD cartridge receiving station opening 146. In all other respects, the MP3 transfer accessory device 100 of the first alternate embodiment is exactly the same as the MP3 transfer accessory device 10 of the preferred embodiment except for the accessory housing 120 receiving the CD cartridge member 174 within the CD cartridge receiving station opening 172.

### Second Alternate Embodiment 200

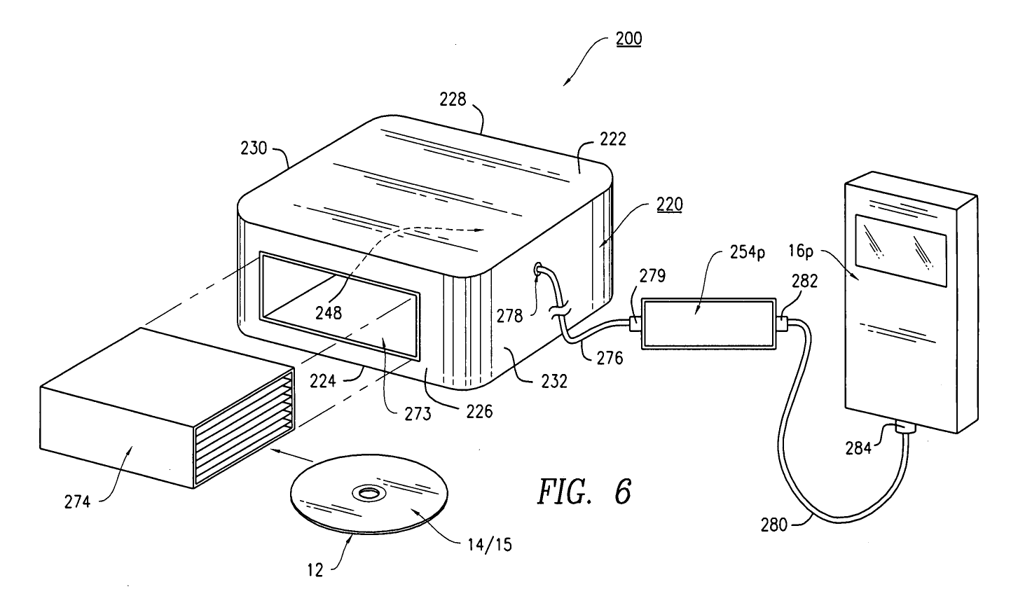

The MP3 transfer accessory device 200 and its component parts of the second alternate embodiment of the present invention are represented in detail by FIG. 6 of the patent drawings. Elements illustrated in FIG. 6 which correspond to the elements described above with reference to FIG. 5 have been designated by corresponding reference numbers increased by one hundred. The second alternate embodiment 200 is similarly constructed and operates in the same manner as the first alternate embodiment 100, unless it is otherwise stated. All aspects of the second alternate embodiment of the MP3 transfer accessory device 200 are the same as the MP3 transfer accessory device 100 except for the design and configuration of accessory housing 220 not having an integrally attached LCD screen 154 and not having an integrally connected docking station compartment 136 (as shown in FIG. 5). A portable LCD screen 254p is electrically connected by electrical wire 276 to a CD reader inlet port 278 of the CD reader 248 and to an LCD screen first inlet port 279 on LCD screen 254p. The MP3 player 16 is electrically connected by electrical wire 280 to an LCD screen second inlet port 282, as shown in FIG. 6 of the patent drawings. Electrical wire 280 is connected to an MP3 inlet port 284. In all other respects, the MP3 transfer accessory device 200 of the second alternate embodiment is exactly the same as the MP3 transfer accessory device 100 of the first alternate embodiment except for the free-standing and portable LCD screen 254p, as shown in FIG. 6.

### OPERATION OF THE PRESENT INVENTION

As shown in FIGS. 1 through 4, the MP3 transfer accessory device 10 operates in the following manner. The user would initially remove the battery compartment cover 40 from the bottom wall 24 of accessory housing 20, where then the user would insert one or more standard batteries 62, or the 9V battery 62b, or the battery pack 62p within the battery compartment 44. Alternatively, the user could electrically charge the transfer accessory device 10 using the standard battery charger 17 with cord and plug 17p being connected to a standard 110V outlet 60 v, and an inlet plug 17i for connecting to the outlet opening 50 using the plug inlet connector member 52, as shown in FIG. 4 of the drawings.

Once the MP3 transfer accessory device 10 has been electrically charged by the above charging means 17, 60, 62b or 62p, the transfer accessory device 10 is now in an operational mode. The user now turns on the power button 58 for activating the power supply 60. The user then inserts a CD 12 into the CD receiving station slot 46, where then the CD reader 48 converts the music tracks 14 selected by the user. Simultaneously, the user inserts the MP3 player 16 to the MP3 docking station compartment 36, which then initiates the transfer of the music tracks 14 of CD 12 to the MP3 player 16. The music 15 will copy seamlessly and directly from the CD 12 to the iPod® 16p. When the transfer is completed, the user then deactivates the power button 58 to an “OFF” mode.

### Advantages of the Present Invention

Accordingly, an advantage of the present invention to provide an MP3 transfer accessory for directly transferring music tracks from a music CD without the use of complex software on a computer for the transfer of the music tracks to an iPod or MP3 player device.

Another advantage of the present invention is to provide an MP3 transfer accessory that increases the speed and efficiency of transferring music tracks on CD's to the MP3 player since because the user does not have to link the MP3 player to a computer.

Another advantage of the present invention is to provide an MP3 transfer accessory that has a CD cartridge being integrally connected to the MP3 transfer accessory for receiving multiple music CD's therein.

Another advantage of the present invention is to provide an MP3 transfer accessory that includes an LCD screen for displaying the progress of transferring the music tracks from the CD, as well as to allow the user to specify which music tracks to copy.

Another advantage of the present invention is to provide an MP3 transfer accessory that reads the music CD, rips the music tracks and compresses the music tracks into a user-defined bitrate of an MPEG3 format.

Another advantage of the present invention is to provide an MP3 transfer accessory that is easy to use with minimal operational push-button functions on the transfer accessory.

A further advantage of the present invention is to provide an MP3 transfer accessory that can be mass-produced in an automated and economical manner and is readily affordable by the consumer.

A latitude of modification, change, and substitution is intended in the foregoing disclosure, and in some instances, some features of the invention will be employed without a corresponding use of other features. Accordingly, it is appropriate that the appended claims be construed broadly and in a manner consistent with the spirit and scope of the invention herein.

What is claimed is:

1) An MP3 transfer accessory for transferring music from a CD to an MP3 player; comprising:
a) a portable housing having a CD receiving station for receiving therein a CD to be uploaded to an MP3 player;
b) said CD receiving station including a CD reader for reading the music tracks on the CD placed within said CD receiving station;
c) said transfer accessory further including means for reading the data in said CD reader and for converting the CD format to MP3 readable format;
d) said housing further including an integral MP3 docking station for receiving an MP3 player therein for receiving music from the CD placed in said CD receiving station;
e) said MP3 docking station including a docking connector for electrically connecting said MP3 player to said transfer accessory;
f) said housing further including an LCD screen for displaying data as to the CD music track being copied and as to the CD music tracks to be copied; and
g) power means for providing power to said transfer accessory, and means for activating and deactivating said power means.

2) An MP3 transfer accessory in accordance with claim 1, wherein said housing further including charging means for charging said MP3 player docked in said MP3 docking station.

3) An MP3 transfer accessory in accordance with claim 1, further including means of converting software for allowing the uploading of the CD and downloading to said MP3 player from said CD reader.

4) An MP3 transfer accessory in accordance with claim 1, wherein said power means are selected from the group consisting of a battery charger device, a battery pack, one or more standard batteries, a 9V battery and an electrical 110V plug for connecting to an electrical 110V outlet.

5) An MP3 transfer accessory in accordance with claim 1, wherein said means for activating and deactivating said power means includes a power ON-OFF button.

6) An MP3 transfer accessory in accordance with claim 1, wherein said means or activating and deactivating said power means includes a power ON-OFF switch.

7) An MP3 transfer accessory in accordance with claim 1, wherein said MP3 docking station further includes a charger receptacle for charging said MP3 player when docked in said MP3 docking station.

8) An MP3 transfer accessory in accordance with claim 1, wherein said sidewall includes an opening for receiving a plug inlet connector member therein.

9) An MP3 transfer accessory in accordance with claim 8, wherein said plug inlet connector member receives a standard battery charger with cord and plug.

10) An MP3 transfer accessory in accordance with claim 1, wherein said means for reading the data in said CD reader includes a software microchip for converting the CD format to MP3 readable format.

11) An MP3 transfer accessory for transferring music from a CD to an MP3 player; comprising:
a) a portable housing having a CD cartridge receiving station for receiving therein a CD cartridge member for multiple CD's to be uploaded to an MP3 player;
b) said CD cartridge receiving station including a CD reader for reading the music tracks on the CD's placed within said CD cartridge member in said CD cartridge receiving station;
c) said transfer accessory further including means for reading the data in said CD reader and for converting the CD format to MP3 readable format;
d) said housing further including an integral MP3 docking station for receiving an MP3 player therein for receiving music from the CD's placed within said CD cartridge member in said CD cartridge receiving station;
e) said MP3 docking station including a docking connector for electrically connecting said MP3 player to said transfer accessory;
f) said housing further including an LCD screen for displaying data as to the CD music track being copied and as to the CD music tracks to be copied; and
g) power means for providing power to said transfer accessory, and means for activating and deactivating said power means.

12) An MP3 transfer accessory for transferring music from a CD to an MP3 player; comprising:
a) a portable housing having a CD cartridge receiving station for receiving therein a CD cartridge member for multiple CD's to be uploaded to an MP3 player;
b) said CD cartridge receiving station including a CD reader for reading the music tracks on the CD's placed within said CD cartridge member in said CD cartridge receiving station;
c) said transfer accessory further including means for reading the data in said CD reader and for converting the CD format to MP3 readable format;
d) said housing further including an integral MP3 docking station for receiving an MP3 player therein for receiving music from the CD's placed within said CD cartridge member in said CD cartridge receiving station; and
e) power means for providing power to said transfer accessory, and means for activating and deactivating said power means.

13) An MP3 transfer accessory in accordance with claim 12, wherein said housing further includes an LCD screen for displaying data as to the CD music track being copied and as to the CD music tracks to be copied.
